(19) United States
(12) Patent Application Publication
(10) Pub. No.: US 2026/0243187 A1
(43) Pub. Date: Aug. 20, 2026

(54) Manifold Module, Engine, And Construction Machinery

(71) Applicant: Caterpillar Inc., Peoria, IL (US)

(72) Inventors: Qiang Zhu, Wuxi City (CN); Wengang Chen, Wuxi (CN); Chase Ketterling, Peoria, IL (US); Matthew Frank Fahrenkrug, Chillicothe, IL (US); Zhenhua Zhang, Wuxi (CN)

(21) Appl. No.: 19/542,994

(22) Filed: Feb. 18, 2026

(30) Foreign Application Priority Data
Feb. 19, 2025 (CN) 202510187874.0

(51) Int. Cl. F01N 3/20; F01N 3/30

(52) U.S. Cl. CPC F01N 3/2066; F01N 3/30; F01N 2610/1406

(57) ABSTRACT

The present disclosure relates to a manifold module, an engine, and a construction machinery. The manifold module comprises: an exhaust treatment fluid feeding unit configured to provide a first transmission path for supplying exhaust treatment fluid from a tank to a nozzle; an air feeding unit configured to provide a second transmission path for supplying air from an air source to the nozzle; a purging unit configured to provide a third transmission path for purging with air. Said manifold module has a main body part, and said first transmission path, second transmission path, and third transmission path each include a channel formed in the main body part.

### CROSS-REFERENCE TO RELATED APPLICATIONS

This application claims priority to prior Chinese Patent Application Number CN 202510187874.0, filed February 19, 2025, which is incorporated herein by reference in its entirety.

### TECHNICAL FIELD

The present disclosure relates to a manifold module for an exhaust treatment fluid adding device in an engine exhaust aftertreatment system, an engine comprising such a manifold module, and a construction machinery.

### BACKGROUND

In current engines, particularly diesel engines used in construction machinerys, an exhaust aftertreatment system is generally provided to meet emission requirements. In the exhaust aftertreatment system, for example, SCR (Selective Catalytic Reduction) technology requires the use of an exhaust treatment fluid, such as a urea aqueous solution. In this case, it is necessary to precisely control the quantitative dosing of the exhaust treatment fluid, i.e., the dosing rate and dosing timing. Additionally, it is necessary to remove the exhaust treatment fluid remaining in the exhaust treatment fluid adding device after quantitative dosing; otherwise, in low-temperature environments, the exhaust treatment fluid may freeze, potentially leading to failure of exhaust aftertreatment components. Therefore, it is necessary to flush or clean the exhaust treatment fluid adding device, especially to perform automatic purging by means of compressed air.

The existing exhaust treatment fluid storage and adding devices occupy too large space, and the components performing the automatic purging function are costly and also occupy too large space.

The present disclosure aims to solve one or more problems existing in the prior art.

### SUMMARY

An aspect of the present disclosure provides a manifold module for an exhaust treatment fluid adding device, comprising:

an exhaust treatment fluid feeding unit configured to provide a first transmission path for supplying exhaust treatment fluid from a tank to a nozzle;

an air feeding unit configured to provide a second transmission path for supplying air from an air source to the nozzle; and

a purging unit configured to provide a third transmission path for purging with air;

wherein said manifold module has a main body part, and said first transmission path, second transmission path, and third transmission path respectively include a channel formed in the main body part.

The method according to the present disclosure achieves the following advantages:

Multiple channels are integrated into a common manifold module to allow for quantitative dosing of exhaust treatment fluid and automatic cleaning at the same time. This not only saves manufacturing costs and reduces installation space, but also makes modular system configuration possible.

Another aspect of the present disclosure relates to an engine for a construction machinery, the engine comprising an exhaust treatment fluid adding device for an exhaust aftertreatment system, the exhaust treatment fluid adding device comprising an exhaust treatment fluid tank, a pump, a manifold module connected to the pump, and a nozzle connected to the manifold module, wherein the manifold module is the manifold module according to the present disclosure.

A further aspect of the present disclosure relates to a construction machinery comprising the aforementioned engine.

### BRIEF DESCRIPTION OF THE DRAWINGS

FIG. 1 is a schematic diagram of an exemplary embodiment of a manifold module according to the present disclosure.

FIG. 2 is a schematic diagram of the manifold module of FIG. 1 together with an installed pump.

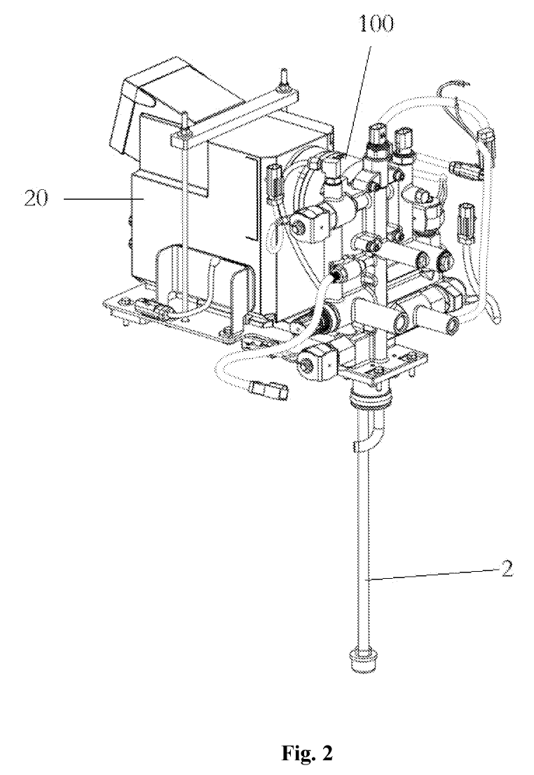

FIG. 3 is a partial cross-sectional view of the manifold module of FIG. 1, showing an exhaust treatment fluid feeding unit.

FIG. 4 is a partial cross-sectional view of the manifold module of FIG. 1, showing an air feeding unit.

FIG. 5 is a schematic diagram of the manifold module of FIG. 1 from another perspective, showing a purge sub-channel segment.

FIG. 6 is a partial cross-sectional view of the manifold module of FIG. 1, showing an air purge path.

### List of Reference Numerals

100 Manifold module

1 Main body part

2 Exhaust treatment fluid suction pipe

3 Exhaust treatment fluid suction channel segment

4 Pump suction connection port

5 Pump discharge connection port

6 Exhaust treatment fluid pumping channel segment

7 Exhaust treatment fluid output interface

8 Air inlet

9 Air outlet

10 First air supply sub-channel segment

11 Second air supply sub-channel segment

12 Purge sub-channel segment

13 Air activation valve

14 Purge valve

15 Connection portion of the purge sub-channel segment

16 Return channel segment

17 Return port

18 Air regulator

19 Exhaust treatment fluid return valve

20 Pump

### DETAILED DESCRIPTION

The manifold module, engine, and construction machinery according to the present disclosure will be described below with reference to the accompanying drawings and through specific embodiments. However, the exemplary embodiments can be implemented in various forms and should not be construed as limited to the embodiments set forth herein; rather, these embodiments are provided to make the present disclosure thorough and complete, and convey the entire concept of the exemplary embodiments to those skilled in the art.

In the following description, directional terms such as "upper," "lower," "left," "right," "vertical direction," and "horizontal direction" are used based on the product being actually installed and in a state of use. In other words, the relative positions of the various components will be described below based on the specific assembly orientation of the product in its application context.

In a construction machinery having an engine, particularly a diesel engine, as a power source, the engine includes an exhaust treatment fluid adding device for an exhaust aftertreatment system. The exhaust treatment fluid adding device comprises an exhaust treatment fluid tank, a pump, a manifold module connected to the pump, and a nozzle connected to the manifold module. The pump draws exhaust treatment fluid from the tank of the exhaust treatment fluid via the manifold module as needed, conveys the exhaust treatment fluid to the nozzle via the manifold module, and then quantitatively doses the exhaust treatment fluid into the exhaust aftertreatment system via the nozzle. According to the present disclosure, an integrated manifold module 100 is provided in the exhaust treatment fluid adding device.

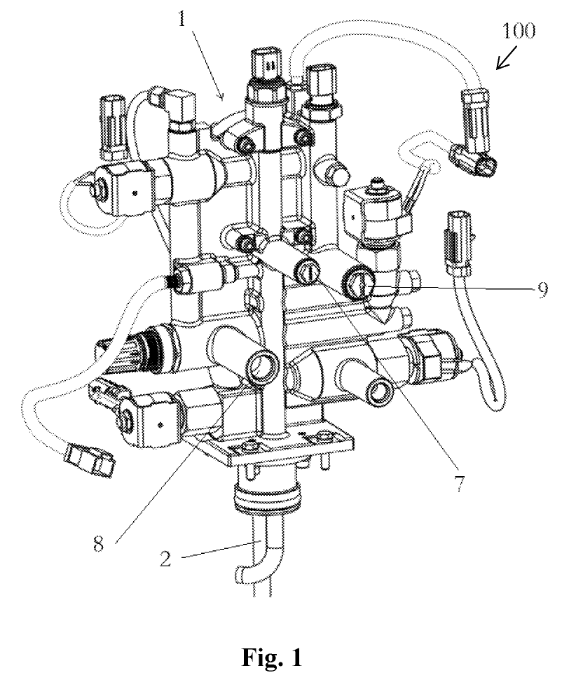

FIG. 1 shows a schematic diagram of an exemplary embodiment of the manifold module 100 according to the present disclosure. This manifold module is an integrated manifold module, meaning the main body part 1 of the manifold module is formed by a single casting. For example, the main body part 1 of the manifold module can be formed by a stainless steel casting. Passages and interfaces are formed within the main body part 1. In this embodiment, the main body part 1 is configured as a flat, rectangular cuboid shape. Here, the side of the main body part 1 toward outside of the page as shown in FIG. 1 is referred to as the first side, and the side opposite to the first side is referred to as the second side.

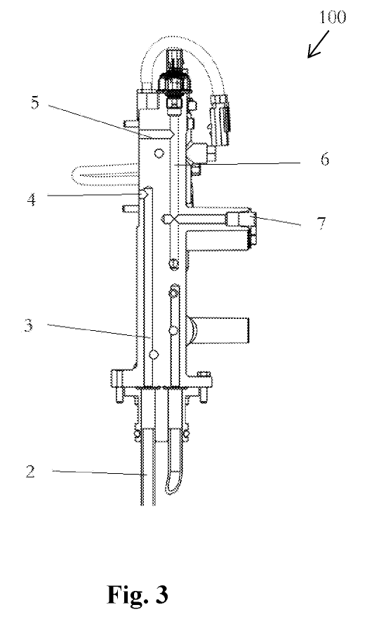

The manifold module 100 includes an exhaust treatment fluid feeding unit configured to provide a first transmission path for supplying exhaust treatment fluid from the tank to the nozzle. The exhaust treatment fluid feeding unit (see FIG. 3) comprises an exhaust treatment fluid suction pipe 2, which is configured as a first pipe member extending downward from the main body part 1 of the manifold module. In the use state, the exhaust treatment fluid suction pipe 2 extends into the tank (not shown) of the exhaust treatment fluid. The exhaust treatment fluid suction pipe 2 can be formed on the main body part 1 during the casting process, for example, or can be connected to the main body part by appropriate connection methods (e.g., welding, threaded connection, etc.). In the use state, the exhaust treatment fluid suction pipe 2 is immersed below a liquid level of the exhaust treatment fluid in the tank, thereby enabling the extraction of the exhaust treatment fluid. The port of the exhaust treatment fluid suction pipe 2 forms an inlet of the first transmission path. The exhaust treatment fluid suction pipe 2 communicates via an exhaust treatment fluid suction channel segment 3 to a pump suction connection port 4. In this embodiment, the exhaust treatment fluid suction channel segment 3 is configured as a channel segment formed substantially centrally in the main body part 1 along a vertical direction. In use, the pump suction connection port 4 can be connected to the suction port (not shown) of a pump 20, and the discharge port of the pump 20 can be connected to a pump discharge connection port 5. The pump suction connection port 4 and the pump discharge connection port 5 are configured as interfaces formed on the main body part 1 and can be collectively referred to as pump interfaces. In this embodiment, the pump suction connection port 4 and the pump discharge connection port 5 are formed on the second side of the main body part 1. The pump discharge connection port 5 communicates via an exhaust treatment fluid pumping channel segment 6 to an exhaust treatment fluid output interface 7. The exhaust treatment fluid output interface 7 forms an outlet of the first transmission path. In the use state, the exhaust treatment fluid output interface 7 is connected to the exhaust treatment fluid interface of the nozzle to supply exhaust treatment fluid to the nozzle. The exhaust treatment fluid pumping channel segment 6 is configured as a channel segment formed substantially centrally in the main body part 1 along the vertical direction. As shown in FIG. 3, the extension direction of the exhaust treatment fluid pumping channel segment 6 is substantially parallel to the extension direction of the exhaust treatment fluid suction channel segment 3. The exhaust treatment fluid output interface 7 is configured as an interface formed on the main body part 1 and is formed on the first side of the main body part 1. The exhaust treatment fluid output interface 7 is formed below the exhaust treatment fluid pumping channel segment 6, so the exhaust treatment fluid in the exhaust treatment fluid pumping channel segment 6 flows downward. Additionally, a pressure sensor may be provided in the exhaust treatment fluid feeding unit to monitor the exhaust treatment fluid pressure. This pressure sensor can be arranged, for example, in the exhaust treatment fluid pumping channel segment 6.

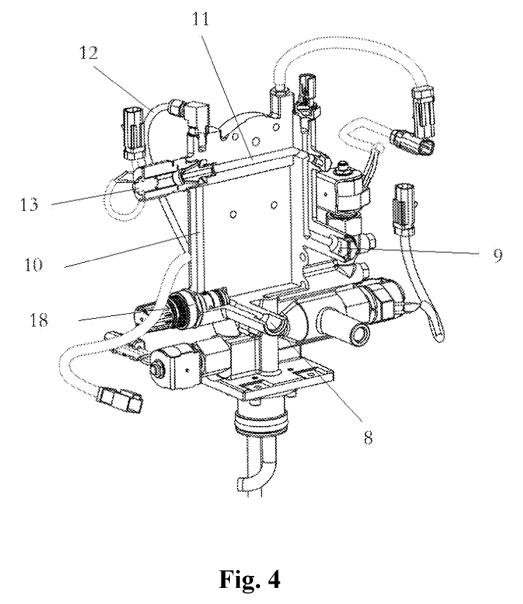

The manifold module 100 further includes an air feeding unit configured to provide a second transmission path for supplying air from an air source to the nozzle, thereby achieving air-assisted quantitative dosing of the exhaust treatment fluid. As shown in FIG. 4, the air feeding unit comprises an air inlet 8, which is used to connect to an outlet of an air compressor or a supply port of another air supply device. The air inlet 8 forms the inlet of the second transmission path. The air inlet 8 communicates via an air supply channel segment formed in the main body part 1 to an air outlet 9. Here, the air inlet 8 and the air outlet 9 are configured as interfaces formed on the first side of the main body part 1. In this embodiment, the air supply channel segment can be divided into a first air supply sub-channel segment 10 and a second air supply sub-channel segment 11. As shown in the figure, the first air supply sub-channel segment 10 is configured as a channel segment formed in the main body part 1 along the vertical direction, near an edge. The second air supply sub-channel segment 11 is configured as a channel segment formed in the main body part 1 along a horizontal direction, near an edge. As can be seen from FIG. 1, the exhaust treatment fluid output interface 7 is located approximately at the center of the first side of the main body part 1. The air inlet 8 is located approximately at the lower left of the first side of the main body part 1, and the air outlet 9 is located on the right side, approximately adjacent to the exhaust treatment fluid output interface 7. The air outlet 9 forms the outlet of the second transmission path. In use, the air outlet 9 is used to connect to an auxiliary air interface of the nozzle to supply auxiliary air to the nozzle. Furthermore, an air regulator 18 may be provided in the air supply channel segment, particularly in the first air supply sub-channel segment 10, by means of which the air can be regulated to a specified pressure range. Additionally, a pressure sensor (not shown) may be provided to monitor the air pressure.

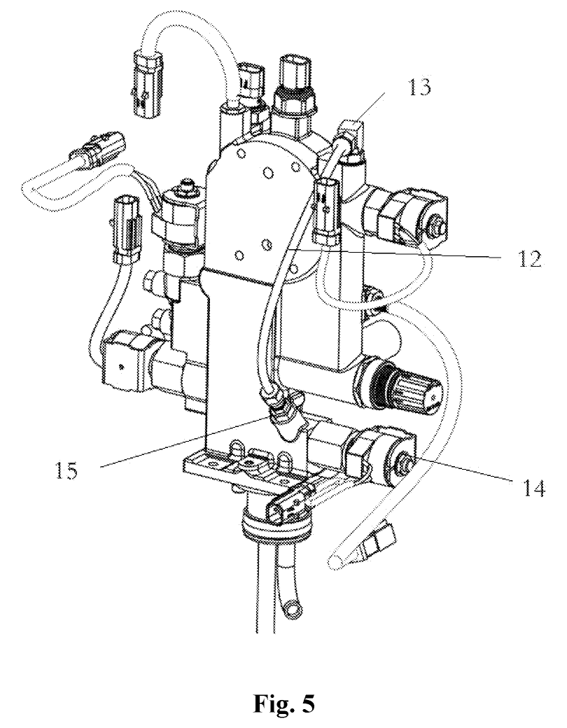

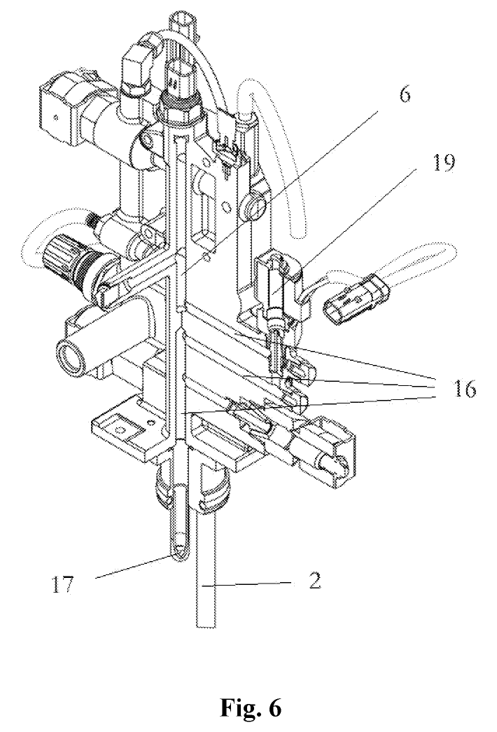

The manifold module 100 further includes a purging unit (see FIGS. 5 and 6). This purging unit is configured to provide a third transmission path for purging with air. In this embodiment, the purging unit shares the air inlet 8 and the first air supply sub-channel segment 10 with the air feeding unit. That is, the third transmission path shares an inlet with the second transmission path. Of course, a separate purge air inlet can also be provided for the purging unit. A purge sub-channel segment 12 branches off at a junction (this junction can also be referred to as the branch portion of the air supply channel segment) between the first air supply sub-channel segment 10 and the second air supply sub-channel segment 11. In this embodiment, the purge sub-channel segment 12 is configured as a hose connected to the main body part 1, particularly on the second side. The purge sub-channel segment 12 is connected at one end to said junction and at the other end, via a connection portion 15 of the purge sub-channel segment, to the exhaust treatment fluid suction channel segment 3. Thus, via this purge sub-channel segment 12, i.e., a pipeline formed outside the main body part 1, the third transmission path is connected to the second transmission path. Of course, it is conceivable that the purge sub-channel segment 12 may be configured in other forms. For example, it is configured as a channel inside the main body part, as long as communication from said junction to the exhaust treatment fluid suction channel segment 3 is created.

Furthermore, an air activation valve 13 is provided at this junction. The air activation valve 13 has two switching states, namely a feeding state and a purging state. In the feeding state of the air activation valve 13, the first air supply sub-channel segment 10 is communicated with the second air supply sub-channel segment 11, making the entire air supply channel segment opened up. In the purging state of the air activation valve 13, the first air supply sub-channel segment 10 is communicated with the purge sub-channel segment 12, while the air supply channel segment is blocked. The air activation valve 13 can be configured, for example, as a two-position three-way valve, particularly as a solenoid valve.

The purge sub-channel segment 12 is connected to the exhaust treatment fluid suction channel segment 3 via a purge valve 14. The purge valve 14 also has two switching states, namely a feeding state and a purging state. In the feeding state of the purge valve 14, the exhaust treatment fluid suction channel segment 3 is communicated with the exhaust treatment fluid suction pipe 2, so that the exhaust treatment fluid can enter the exhaust treatment fluid suction channel segment 3 from the exhaust treatment fluid suction pipe 2, but the connection between the purge sub-channel segment 12 and the exhaust treatment fluid suction channel segment 3 is disconnected. In the purging state of the purge valve 14, the exhaust treatment fluid suction channel segment 3 is communicated with the purge sub-channel segment 12, so that the purge air can enter the exhaust treatment fluid suction channel segment 3 from the purge sub-channel segment 12, but the connection between the exhaust treatment fluid suction channel segment 3 and the exhaust treatment fluid suction pipe 2 is disconnected. The purge valve 14 is configured, for example, as a two-position three-way valve, particularly as a solenoid valve.

In addition to being connected to the exhaust treatment fluid output interface 7 as described above, the exhaust treatment fluid pumping channel segment 6 is also connected to a return channel segment 16, which leads to a return port 17. Therefore, the exhaust treatment fluid pumping channel segment 6 is a channel section shared by the third transmission path and the first transmission path. The return channel segment 16 extends into the tank of the exhaust treatment fluid at the return port 17, and the return port 17 is located above the liquid level of the exhaust treatment fluid in the tank. Therefore, the exhaust treatment fluid carried by the purge air can return to the tank via the return port 17. Here, the return channel segment 16 comprises a channel formed in the main body part 1 and a second pipe member extending downward from the main body part 1. The return port 17 is configured as a port of said second pipe member. The return port 17 forms an outlet of the third transmission path.

Furthermore, an exhaust treatment fluid return valve 19 is provided in the return channel segment 16. This exhaust treatment fluid return valve 19 is configured, for example, as a simple on-off valve, particularly as a solenoid valve. When the exhaust treatment fluid return valve 19 is open, the return channel segment 16 is communicated with the return port 17. When the exhaust treatment fluid return valve 19 is closed, the return channel segment 16 is blocked.

The present disclosure also relates to an engine. This engine includes an exhaust aftertreatment system. The manifold module 100 as described above is provided in the exhaust aftertreatment system for dosing exhaust treatment fluid. The present disclosure also relates to a construction machinery comprising such an engine.

### Industrial Applicability

The operation of the manifold module 100 is described below.

In the dosing mode of the exhaust treatment fluid, the pump 20 is operated. The air activation valve 13 is set to the feeding state, making the first air supply sub-channel segment 10 communicated with the second air supply sub-channel segment 11. The purge valve 14 is set to the feeding state, making the entire exhaust treatment fluid suction channel segment 3 opened up. The exhaust treatment fluid return valve 19 is closed, making the return channel segment 16 blocked.

The exhaust treatment fluid is drawn from the tank of the exhaust treatment fluid via the exhaust treatment fluid suction pipe 2, enters the exhaust treatment fluid suction channel segment 3 via the purge valve 14 in the feeding state, and is then delivered to the pump 20. Subsequently, the exhaust treatment fluid delivered from the pump 20 is conveyed through the exhaust treatment fluid pumping channel segment 6 to the exhaust treatment fluid interface of the nozzle.

Optionally and simultaneously, compressed air from, for example, an air compressor enters through the air inlet 8, then passes through the first air supply sub-channel segment 10 and the air activation valve 13 in the feeding state to reach the second air supply sub-channel segment 11, and is then delivered to the auxiliary air interface of the nozzle. Here, the pressure of the compressed air can be regulated using the air regulator 18.

In the cleaning mode (which may also be referred to as the purge mode) of the exhaust treatment fluid, the pump 20 is not operated. However, it is also conceivable to operate the pump 20 to pump the compressed air. The air activation valve 13 is set to the purging state, making the first air supply sub-channel segment 10 communicated with the purge sub-channel segment 12. The purge valve 14 is set to the purging state, making the exhaust treatment fluid suction channel segment 3 communicated with the purge sub-channel segment 12. The exhaust treatment fluid return valve 19 is opened, making the return channel segment 16 opened up.

Under these conditions, the compressed air enters the manifold module 100 via the air inlet 8, and enters the purge sub-channel segment 12 via the first air supply sub-channel segment 10 and the air activation valve 13 in the purging state. Then, the compressed air enters the exhaust treatment fluid suction channel segment 3 via the purge valve 14 in the purging state. After the compressed air flows through the pump and the exhaust treatment fluid pumping channel segment 6, a portion of the compressed air reaches the return channel segment 16, and another portion reaches the exhaust treatment fluid interface of the nozzle. The portion of air reaching the return channel segment 16, along with any residual exhaust treatment fluid it carries, exits through the return port 17. The portion of air reaching the exhaust treatment fluid interface of the nozzle is mostly returned due to the backpressure of the nozzle itself. The returned compressed air also reaches the return channel segment 16 and, along with any residual exhaust treatment fluid it carries, exits through the return port 17.

Thereby, the purging of the entire exhaust treatment fluid adding device is completed.

It will be apparent to those skilled in the art that various modifications and variations can be made to the embodiments disclosed herein without departing from the scope or spirit of the present disclosure. Other embodiments of the present disclosure will be apparent to those skilled in the art from consideration of the specification and practice of the present disclosure as disclosed herein. The specification and examples disclosed herein are to be considered exemplary only.

1. A manifold module for an exhaust treatment fluid adding device, comprising:
an exhaust treatment fluid feeding unit configured to provide a first transmission path for supplying exhaust treatment fluid from a tank to a nozzle;
an air feeding unit configured to provide a second transmission path for supplying air from an air source to the nozzle; and
a purging unit configured to provide a third transmission path for purging with air;
characterized in that,
said manifold module has a main body part, and said first transmission path, second transmission path, and third transmission path respectively include a channel formed in the main body part.

2. The manifold module according to claim 1, characterized in that said first transmission path, second transmission path, and third transmission path each include an interface formed on the main body part,
the first transmission path has an inlet configured as a port of a first pipe member extending out from the main body part and extending downward, and has an outlet configured as an interface formed on a first side of the main body part, wherein the first transmission path is provided with a pump interface located on a second side, which is opposite to said first side, of the main body part, and a pump is connectable to the main body part via said pump interface,
the second transmission path has an inlet configured as an interface formed on the first side of the main body part, and has an outlet configured as an interface formed on the first side of the main body part;
the third transmission path shares an inlet with the second transmission path; the third transmission path includes a pipeline located outside the main body part and is capable of communicating with the second transmission path through said pipeline; the third transmission path further includes a channel section shared with the first transmission path and a return channel segment formed in the main body part.

3. The manifold module according to claim 1, characterized in that said main body part is configured as an integral component formed by a casting, wherein said casting is a stainless steel casting.

4. The manifold module according to claim 1, characterized in that said exhaust treatment fluid feeding unit comprises:
an exhaust treatment fluid suction pipe,
an exhaust treatment fluid suction channel segment in communication with the exhaust treatment fluid suction pipe,
a pump suction connection port being in communication with the exhaust treatment fluid suction channel segment and being installable to connect to a suction port of a pump,
a pump discharge connection port being installable to connect to a discharge port of the pump,
an exhaust treatment fluid pumping channel segment in communication with the pump discharge connection port,
an exhaust treatment fluid output interface being in communication with the exhaust treatment fluid pumping channel segment and being installable to connect to an exhaust treatment fluid interface of the nozzle.

5. The manifold module according to claim 4, characterized in that,
the exhaust treatment fluid suction pipe is configured as a first pipe member extending out from the main body part and extending downward;
the exhaust treatment fluid suction channel segment is configured as a channel formed in the main body part, and is formed centrally in the main body part along a vertical direction;
the pump suction connection port is configured as an interface formed on the main body part, and is formed on the second side of the main body part;
the pump discharge connection port is configured as an interface formed on the main body part, and is formed on the second side of the main body part;
the exhaust treatment fluid pumping channel segment is configured as a channel formed in the main body part, and is formed centrally in the main body part along the vertical direction;
the exhaust treatment fluid output interface is configured as an interface formed on the main body part, and is formed on the first side, which is opposite to the second side, of the main body part.

6. The manifold module according to claim 4, characterized in that said air feeding unit comprises:
an air inlet being installable to connect to an air source,
an air supply channel segment in communication with the air inlet,
an air outlet being in communication with the air supply channel segment and being installable to connect to an auxiliary air interface of the nozzle.

7. The manifold module according to claim 6, characterized in that,
the air inlet is configured as an interface formed on the main body part, and is formed on the first side of the main body part;
the air supply channel segment is configured as a channel formed in the main body part;
the air outlet is configured as an interface formed on the main body part, and is formed on the first side of the main body part.

8. The manifold module according to claim 6, characterized in that said purging unit comprises:
a purge sub-channel segment branching off at a branch portion of the air supply channel segment, said purge sub-channel segment being connected to the exhaust treatment fluid suction channel segment,
a return channel segment connected to the exhaust treatment fluid pumping channel segment,
a return port connected to the return channel segment.

9. The manifold module according to claim 8, characterized in that said purging unit comprises:
an air activation valve arranged between the branch portion of the air supply channel segment and the purge sub-channel segment, wherein said air activation valve divides the air supply channel segment into a first air supply sub-channel segment and a second air supply sub-channel segment; said air activation valve has a feeding state and a purging state, in the feeding state of the air activation valve, the first air supply sub-channel segment is communicated with the second air supply sub-channel segment, and in the purging state of the air activation valve, the first air supply sub-channel segment is communicated with the purge sub-channel segment;
a purge valve arranged between the purge sub-channel segment and the exhaust treatment fluid suction channel segment, wherein said purge valve has a feeding state and a purging state, in the feeding state of the purge valve, the exhaust treatment fluid suction channel segment is communicated with the exhaust treatment fluid suction pipe, and in the purging state of the purge valve, the exhaust treatment fluid suction channel segment is communicated with the purge sub-channel segment,
an exhaust treatment fluid return valve arranged in the return channel segment, wherein when the exhaust treatment fluid return valve is open, the return channel segment is communicated with the return port, and when the exhaust treatment fluid return valve) is closed, the return channel segment is blocked.

10. The manifold module according to claim 9, characterized in that,
the purge sub-channel segment is configured as a hose connected to the main body part, said hose being connected with one end to the air activation valve and with the other end to the exhaust treatment fluid suction channel segment, and said hose being arranged on the second side of the main body part;
the return channel segment includes a channel formed in the main body part and a second pipe member extending downward from the main body part;
the return port is configured as a port of the second pipe member,
the first air supply sub-channel segment is configured as a channel segment formed in the main body part along the vertical direction,
the second air supply sub-channel segment is configured as a channel segment formed in the main body part along a horizontal direction.

11. An engine, comprising an exhaust treatment fluid adding device for an exhaust aftertreatment system, said exhaust treatment fluid adding device comprising an exhaust treatment fluid tank, a pump, a manifold module connected to the pump, and a nozzle connected to the manifold module, characterized in that said manifold module is the manifold module according to claim 1.

12. A construction machinery, comprising the engine according to claim 11.
